(19) United States
(12) Patent Application Publication
(10) Pub. No.: US 2012/0139237 A1
(43) Pub. Date: Jun. 7, 2012

(54) PIPE CONNECTION AND DEVICE FOR FORMING A PIPE CONNECTION

(76) Inventors: Karl Böhm, Holzhausen (AT); Walter Karpellus, Innsbruck (AT)

(21) Appl. No.: 13/389,881

(22) PCT Filed: Jul. 14, 2010
(86) PCT No.: PCT/AT10/00262

§ 371 Date: Feb. 10, 2012

(30) Foreign Application Priority Data
Aug. 12, 2009 (GM) 5052009

(51) Int. Cl. F16L 21/00; B21D 39/04

(52) U.S. Cl. 285/399; 29/282

(57) ABSTRACT

In a pipe connection between a first pipe and a second pipe, wherein an end section of the one pipe is designed as a pointed end and embraced by an end section of the other pipe, which end section is in the form of a sleeve end, wherein the pointed end has a reduced diameter in comparison to the pipe circumference, it is provided that a depression extending at least over a partial region of the circumference of the pointed end is formed on that end region of the pointed end which faces away from the pipe end.

The present invention relates to a pipe connection between a first pipe and a second pipe, wherein an end section of the one pipe is designed as a pointed end and embraced by an end section of the other pipe, which end section is in the form of a sleeve end, wherein the pointed end has a reduced diameter in comparison to the pipe circumference, and a device for forming a pipe connection, including a clamping or holding means for holding an end section of a pipe, in particular a mountain-side pipe, which end section is designed as a sleeve end, a guiding and adjusting device for introducing into the end section designed as a sleeve end a pipe section of another pipe, in particular an extension pipe, which pipe section is designed as a pointed end.

Pipe connections between a first pipe and a second pipe are known in the most different embodiments, wherein both detachable connections and permanent connections are manifoldly used. In the event of detachable connections, pipes, in practice, are for instance screwed together by the aid of threads, either directly or by using a sleeve. In the event of permanent connections, the connection is made by gluing, welding or riveting. Such permanent connections, as a rule, cannot be undone any more without destroying the end sections of the pipes connected to each other.

It is known, particularly in the mining sector when drilling holes in soil or rock material, to sheath the drill rod assembly by so-called jacket tubes, which can be driven in simultaneously with the drill rod assembly and/or entrained by the same. When extending such jacket tubes, it has so far been common practice to either directly screw together the jacket tube ends or arrange a screw sleeve over jacket tube ends to be connected to each other. Such connections by the aid of threads, on the one hand, are technically elaborate and, on the other hand, involve high costs, since appropriate threads have to be cut into the pipe ends and exactly screwed together subsequently in order to safely avoid wedging or jamming of the pipe ends, and hence their becoming useless. Besides, threaded connections are completely rigid, which may be disadvantageous particularly when used in mining.

From WO 2005/103547, a pipe connection has become known, in which two pipes are inserted into each other as far as to a stop respectively provided in the pipe ends, whereupon the pipe end designed as a sleeve end is pressed onto the pipe end designed as a pointed end by the application of a pressure force. In order to achieve an immobile connection, a plurality of circumferentially extending depressions that are mutually spaced apart in the longitudinal direction of the pipe are provided in the pipe end designed as a pointed end.

Particularly when producing anchorages or pipe shields for the formation of tunnels or passages in soil or rock materials, large lengths of such anchorages or pipe shields are frequently required to ensure proper securement. When producing such anchorages or pipe shields, it is, moreover, to be anticipated that, for instance, due to different soil or rock materials, displacements between individual soil or rock layers may partly occur, which may cause loads on the anchorages or on elements of pipe shields in a sense deviating from the longitudinal extension of such tubular elements and, in particular, transverse or inclined relative to said longitudinal extension. If such a load deviating from the longitudinal extension is exerted on the tubular element or pipe, damage to the connection, or buckling of the pipe, or even cutting of an inwardly located sharp-edged end section of a pipe designed as a pointed end into the surrounding end section of the other pipe, may occur especially where the pipes or pipe ends to be connected to each other are rigidly connected to each other, so that an appropriate strength or integrity of the pipe connection will no longer be ensured, particularly in the region of the mutual connection of the two pipes, whereby the safety to be achieved by such pipes will no longer be ensured or sufficiently provided.

The present invention aims to provide a pipe connection which, on the one hand, can be produced quickly and reliably without major expenditures and, on the other hand, is able to follow, or adapt to, the displacements between individual soil or rock layers frequently occurring in soil or rock material, without impairing the pipe connection.

To solve this object, the present invention is characterized in that a depression extending at least over a partial region of the circumference of the pointed end is formed on that end region of the pointed end which faces away from the pipe end. In that the end region of the pointed end comprises a depression extending at least over a partial region of the circumference of the pointed end, it has become possible to provide a pipe connection that is merely formed by pressing the pipe end designed as a sleeve end into said depression. Due to its extremely small extension in the longitudinal direction of the pipe, such a pipe connection offers some flexibility to the effect that displacements in the soil or rock material can be followed, and bending of the entire pipe in the region of the pipe connection can be admitted to some extent, without causing damage to the pipe connection or one of the pipes.

To form a safe and reliable connection between the two pipe ends, the invention is further developed to the effect that the depression is designed as a symmetrical or asymmetrical U-shaped, or a symmetrical or asymmetrical V-shaped, depression. By the depression being designed as a symmetrical or asymmetrical U-shaped or V-shaped depression, it has become possible to safely and reliably press the free end of the pipe in the form of a sleeve end into the depression, and hence provide a permanent support of the sleeve end within the depression. Especially durable and permanent connections will be provided in that the symmetrically or asymmetrically configured U-shaped or V-shaped depressions are each angularly joined to each other rather than formed with rounded-off regions or bottom surfaces, thus ensuring a particularly firm engagement of the sleeve end.

In order to obtain a particularly stable and precise pipe connection, the invention is further developed to the effect that the legs of the symmetrical or asymmetrical U-shaped depression each enclose an obtuse angle with the base of the U-shaped depression, or the legs of the symmetrical or asymmetrical V-shaped depression enclose an obtuse angle with each other. By forming an obtuse angle between the legs and the basis of a symmetrical or asymmetrical U-shaped depression, or an obtuse angle between the legs of the V-shaped depression, it is possible to both achieve a safe support of the sleeve end in the depression and, at the same time, ensure that no damage of the sleeve end in the region of the connection will occur so as to reliably prevent the tearing or inadvertent detachment of the pipe connection.

To form, in particular, a precise and reliable pipe connection, the invention is further developed to the effect that a leg of the depression facing away from the free end of the pointed end is designed as a stop for the free end of the end section in the form of a sleeve end, of the other pipe. In that a leg of the depression facing away from the free end of the pointed end is designed as a stop for the free end of the end section in the form of a sleeve end, of the other pipe, it is feasible to ensure that the pipe designed as a pointed end can be inserted into the sleeve end only as far as to a predetermined penetration depth, since, when the sleeve end hits against the leg of the depression facing away from the free end of the pointed end, any further insertion of the pointed end into the sleeve end will be prevented. In addition, such a configuration ensures that a certain mobility of the connection in respect to the longitudinal extension of the pipe will be possible so as to enable displacements between individual soil and rock layers during the introduction of a long pipe into the soil or rock material to be followed in a safe and, in particular, damage-free manner.

In order to further enhance the mobility of the pipe connection and, in particular, the two mutually connected pipe parts relative to each other in respect to the longitudinal axis of the pipe, and to additionally ensure the safe, reliable and simple introduction of the pointed end of the one pipe into the sleeve end of the other pipe, the invention is further developed to the effect that the pointed end of the one pipe comprises a conically tapering, free end section, and the conically tapering, free end section of the pointed end of the one pipe additionally has a conical angle of 0.8 to 1.5°. By the pointed end of the one pipe having a conically tapering end section and the conically tapering, free end section additionally having a conical angle of 0.8 to 1.5°, the simple introduction of the pointed end of the one pipe into the sleeve end of the other pipe will be feasible, on the one hand, and the desired adaptability to displacements or dislocations between individual soil or rock layers, of a connection of mutually adjoining pipes will even better be ensured, on the other hand.

In order to simplify the connection and, in particular, to reliably prevent a material fracture or the destruction of the free end section of the sleeve end, the invention is further developed to the effect that the end section in the form of a sleeve end, of the other pipe comprises at least one, in particular two, predetermined bending point(s). By providing at least one predetermined bending point, it is feasible to safely and reliably press the end section in the form of a sleeve end, of the other pipe into the depression of the pipe designed as a pointed end, without causing a material destruction or fractures or fissures in the material of the sleeve end such that a safe and load-resistant pipe connection will be provided. In that the predetermined bending point is comprised of a material taper, groove, flute or the like, as in correspondence with a further development of the invention, it is feasible to ensure the precise adaptation of the sleeve end to the depression, with, in particular, the above-mentioned disadvantages of a tearing of the material or breaking of the sleeve end being excluded.

In order to ensure a particularly precise abutment of the end section in the form of a sleeve end, of the other pipe in the depression of the pipe designed as a pointed end after pressing, the invention is further developed to the effect that at least one predetermined bending point is formed on the inner circumference of the end section in the form of a sleeve end, of the other pipe, and that the at least one predetermined bending point is spaced apart from the free end of the sleeve end by the mean diameter of the depression. In that the predetermined bending point on the inner circumference of the pipe in the form of a sleeve end is spaced apart from the free end of the sleeve end by the mean diameter of the depression, a safe and reliable pipe connection will be produced between the two pipes to be connected due to the exact positioning of the free end of the sleeve end, and it will be additionally safeguarded that the maximally possible contact surface between the pipes to be connected will be achieved, since the maximally possible length of a sleeve end is pressed into the depression, whereby such a pipe connection will resist even extreme loads.

In particular when forming the depression as a U-shaped depression, the retention of the sleeve end in the pointed end will be further improved in that at least one further predetermined bending point is formed on an outer circumference of the end section in the form of a sleeve end, of the other pipe, and that said at least one further predetermined bending point is formed to be offset relative to the at least one first predetermined bending point in the direction of the free end of the sleeve end. By providing a further predetermined bending point, it is feasible to completely adapt to the inner contour of the depression, and press into the latter, the free end of the pipe in the form of a sleeve end so as to not only provide a safe and reliable support but, at the same time, be able to thereby ensure a sufficient mobility of the two mutually connected pipes to adapt to displacements in the soil and rock material.

The present invention further aims to provide a device for forming a pipe connection as described above, in order to enable existing devices for drilling holes in soil or rock material to be safely and reliably provided with a secure pipe connection capable of being, in particular, adapted to displacements of the soil and rock material without requiring major modifications.

A device of this type is characterized in that a pressing device for pressing the free end of the pipe section in the form of a sleeve end into the depression of the pipe section of the other pipe, which pipe section is designed as a pointed end, by applying a pressure force, in particular a pressure force directed radially to the pipe interior, comprises a pressing element and a device for applying a pressure force on the pressing element. In that a pressing device for pressing the free end of the pipe section in the form of a sleeve end into the depression of the pipe section of the other pipe, which pipe section is designed as a pointed end, by applying a pressure force, in particular a pressure force directed radially to the pipe interior, comprises a pressing element and a device for applying a pressure force on the pressing element, it has become possible to adapt in a simple manner devices existing in the mining sector for producing, for instance, threaded connections between pipes, in that the known device, which would screw the pipes together hydraulically, is replaced with a pressing element and a device for applying a pressure force on the pressing element, which will apply on the pipe designed as a sleeve end a pressure force directed radially to the pipe interior in a selectively positioned manner.

By further developing the invention to the effect that the guiding and adjusting device comprises a stroke or displacement path corresponding to a depth of penetration of the pipe section designed as a pointed end into the pipe section designed as a sleeve end, it will be safeguarded that the pointed end will be introduced exactly as far as to the stop of the free end of the sleeve end on the leg of the depression facing away from the end region of the pointed end facing away from the pipe end, thus ensuring the exact relative positioning of the two pipes, that is required for a reliable pipe connection.

By further developing the invention to the effect that the pressing element being comprised of an expansion sleeve provided with a pressing cone, the simple and destruction-free introduction of the two pipes into each other, on the one hand, and of the free end of the pipe designed as a sleeve end into the pressing device, on the other hand, will be ensured in that the expansion sleeve, during the introduction procedure, will be expanded to such an extent as to allow the free end of the pipe designed as a sleeve end to be safely and reliably introduced into the pressing device.

By further developing the invention to the effect that the device for applying the pressure force on the pressing element is comprised of a hydraulic cylinder in particular a double-acting hydraulic cylinder, it will be possible, on the one hand, to adapt existing hydraulic devices and, on the other hand, to avoid any possible damage during the production of the connection by selectively choosing the pressure to be exerted on the pipes to be connected.

According to a further development of the invention the device is provided such that a pressing wedge cooperating with a hydraulic hollow cylinder and/or fixed thereto acts on the pressing element, or the pressing element configured as an expansion sleeve, it is feasible, by merely displacing the cylinder rod of the hydraulic hollow cylinder and simultaneously displacing the pressing wedge cooperating therewith and/or fixed thereto, in the direction of the free ends of the pipes to be connected to each other, to safely and reliably apply the force required for pressing the free end of the pipe designed as a sleeve end into the depression formed in the pointed end in order to press the free end of the pipe designed as a sleeve end into the depression of the pipe designed as a pointed end.

A device of this type thus enables the safe and reliable introduction of a pipe connection according to the present invention by pressing the free end of a pipe designed as a sleeve end into a depression of a pipe section designed as a pointed end without major structural modifications of current devices.

In the following, the invention will be described in more detail by way of exemplary embodiments illustrated in the drawing. Therein:

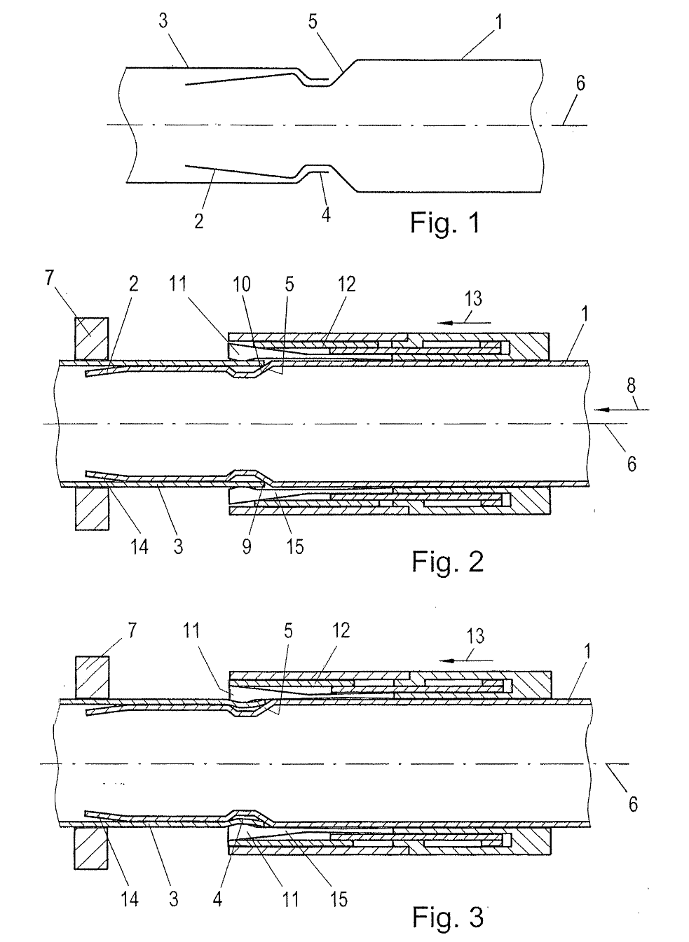

FIG. 1 is a schematic longitudinal section through a pipe connection according to the present invention;

FIG. 2 depicts a longitudinal section through a schematic illustration of two pipes to be connected to each other and through the device for connecting the pipes in an operating position in which the pipes are not yet connected;

FIG. 3 is an illustration analogous to that of FIG. 2, showing the operating position of the device, in which the two pipes have already been connected to each other;

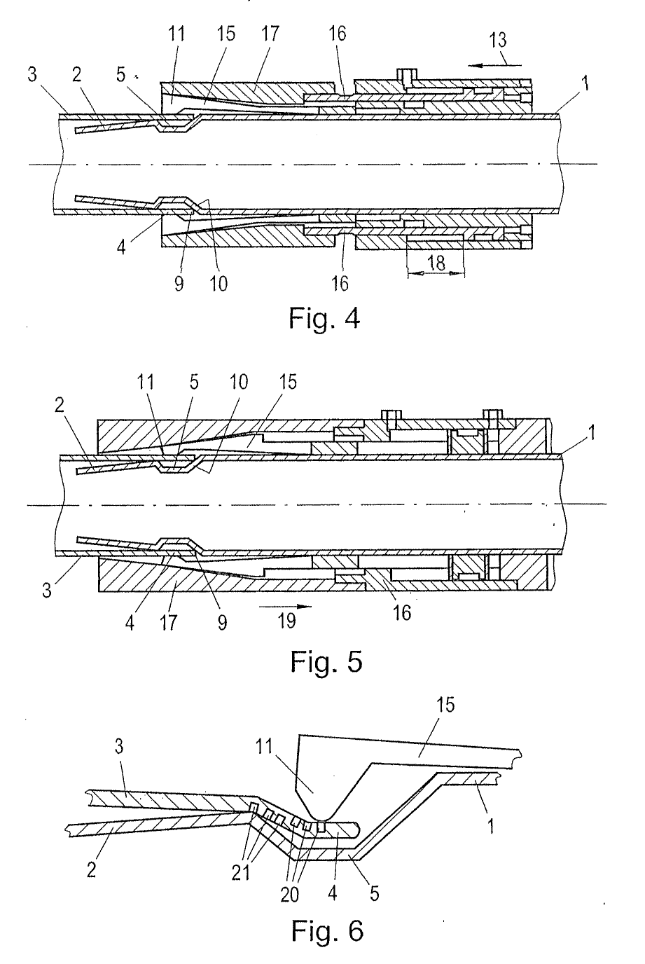

FIG. 4 depicts a longitudinal section through a modified variant of a device for connecting two pipe sections according to the present invention;

FIG. 5 depicts a further modified variant of a device for connecting two pipe sections to be connected to each other; and

FIG. 6 is a schematic partial view of the pressing cone and the pipe ends to be connected to each other.

FIG. 1 in detail depicts a pipe connection according to the present invention, in which a first pipe 1, which comprises an end section designed as a pointed end 2, is inserted into a second pipe 3, which comprises an end section designed as a sleeve end. The free end 4 of the end section designed as a sleeve end, of the pipe 3 in this case is pressed in a depression 5 of the end section designed as a pointed end 2, of the pipe 1. By such pressing-in of the free end section 4 of the pipe 3 designed as a sleeve end into the depression 5 of the pipe 1 designed as a pointed end 2, a connection of the two pipes that can be subjected to both tension and pressure will be achieved.

In that the pipe section designed as a pointed end 2 is further configured to conically taper, a certain movement of the two pipes 1 and 3 in respect to the longitudinal extension of the pipes is, at the same time, enabled such that the pipe connection will be able to adapt, for instance, to displacements in the soil and rock material during the introduction of the pipe connection into the same. Such a pipe connection will allow for an excursion of the pipe 1 relative to the longitudinal axis of the pipe connection by the conical angle without causing destruction and damage.

FIG. 2 schematically depicts a longitudinal section through two pipes to be connected to each other and through an embodiment of a device for connecting the pipes. The pipe 3 comprising the sleeve end, which constitutes the mountain-side pipe, is held by a holding device schematically illustrated by 7, and the pipe 1 comprising a pointed end 2 is inserted into the pipe 3 in the sense of arrow 8 until the free end 9 of the pipe 3 strikes against the leg 10 facing away from the pointed end 2, of the depression 5. For such insertion, the free end 9 of the pipe 3 is guided to below the spring-loaded pressing cone 11, whereupon, in order to produce the pipe connection, the double-acting cylinder 12 is actuated and displaced in the sense of arrow 13 into its end position illustrated in FIG. 3, thus causing the pressing cone 11 to exert pressure on the end section 4 of the pipe 3 and press the same into the depression 5.

FIG. 3 depicts the position of the pressing device according to FIG. 2, in which the free end section 4 of the pipe is pressed in the depression 5. In the illustration according to FIG. 3, the double-acting cylinder 12 has been displaced in the sense of arrow 13 to such an extent that the maximum pressure force will act on the pressing cone 11. FIGS. 2 and 3 depict an embodiment of the pipe 1, in which the pointed end 2 of the pipe 1 is designed to conically taper only in the region of its free end in order to facilitate the insertion of the free end 14 of the pointed end 2 into the pipe 3 forming the sleeve end. In the embodiments according to FIGS. 2 and 3, the major portion of the longitudinal extension of the pointed end 2 tightly abuts on the pipe 3 such that only a slight movement of the pipes relative to each other, and a slight movement relative to the axis 6, is enabled in a pipe connection according to FIGS. 2 and 3.

FIG. 4 depicts a modified variant of a device for pressing the pipes 1 and 3, wherein the state prior to pressing the end section 4 into the depression 5 is illustrated for the device according to FIG. 4. The illustration according to FIG. 4, in which the reference numerals have been retained, again shows an expansion sleeve 15 including the pressing cone 11, into which expansion sleeve the free end section 4 of the pipe 3 is inserted until the free end 9 of the pipe 3 reaches the stop on the leg 10 of the depression 5. In order to apply on the expansion sleeve 15, and hence the pressing cone 11, the pressure required for pressing the end section 4 into the depression 5, a pressing wedge 17 connected and, in particular, screwed to the cylinder rod 16 is displaced in the sense of arrow 13, an accordingly radially inwardly directed pressure is applied on the pressing cone 11, by which the free end section 4 is pressed into the depression 5. The maximum stroke of the cylinder rod 6 is indicated by 18 in FIG. 4.

FIG. 5 depicts a further variant of a device for pressing the pipes 3 and 1. In the variant according to FIG. 5, the free end section 4 of the pipe 3 designed as a sleeve end is again slipped onto the end region of the pipe 1 designed as a pointed end 2 until the free end 9 of the pipe 3 strikes against the leg 10 of the depression 5. For pressing the free end section 4 into the depression 5, the expansion sleeve 15 including the pressing cone 11 in the configuration according to FIG. 5 is subjected to pressure by the pressing wedge 17 being displaced in the sense of arrow 19. By a displacement in the sense of arrow 19, the pressure applied on the pressing cone 11 is increased until the free end section 4 of the pipe 3 is pressed into the depression 5 of the pipe 1.

In the variant according to FIG. 5, the pressing wedge 17 is again connected to the piston rod 16.

Finally, a detail of the pipe connection and, schematically, a portion of the expansion sleeve 15 comprising the pressing cone are illustrated in FIG. 6. By the pressing cone 11 acting exactly on the end section 4 of the pipe 3, the end section 4 of the pipe 3, which comprises predetermined bending points 20 in the form of grooves or flutes 21, is pressed into the depression 5 of the pipe end section designed as a pointed end 2, of the pipe 1. By providing the predetermined bending points 20, which are formed by grooves or flutes 21, it is possible to bring the end section 4 exactly in abutment on the shape of the depression 5 without causing any damage whatsoever to the end section 4 of the pipe 3, thus enabling the provision of a safe and reliable pipe connection.

By configuring the pipe 1 region designed as a pointed end 2 in the form of a cone tapering towards the pipe interior, a certain mobility of the pipe connection is, moreover, provided so as to reliably ensure the adaptation of the pipe connection to terrain displacements and the like, without causing damage to the pipes 1, 3.

1. A jacket pipe connection between a first pipe (1) and a second pipe (3), wherein an end section of the one pipe (1) is designed as a pointed end (2) and embraced by an end section (4) of the other pipe (3), which end section (4) is in the form of a sleeve end, wherein the pointed end (2) has a reduced diameter in comparison to the pipe circumference, characterized in that a depression (5) extending at least over a partial region of the circumference of the pointed end (2) is formed on that end region of the pointed end (2) which faces away from the pipe end.

2. A jacket pipe connection according to claim 1, characterized in that the depression (5) is designed as a symmetrical or asymmetrical U-shaped, or a symmetrical or asymmetrical V-shaped, depression.

3. A jacket pipe connection according to claim 2, characterized in that the legs of the symmetrical or asymmetrical U-shaped depression (5) each enclose an obtuse angle with the base of the U-shaped depression, or the legs of the symmetrical or asymmetrical V-shaped depression enclose an obtuse angle with each other.

4. A jacket pipe connection according to claim 1, 2 or 3, characterized in that a leg (10) of the depression (5) facing away from the free end of the pointed end (2) is designed as a stop for the free end (9) of the end section (4) in the form of a sleeve end, of the other pipe.

5. A jacket pipe connection according to any one of claims 1 to 4, characterized in that the pointed end (2) of the one pipe (1), which projects into the sleeve end of the other pipe (3), comprises a conically tapering end section (14), and that the conically tapering, free end section (14) of the pointed end of the one pipe has a conical angle of 0.8 to 1.5°.

6. A jacket pipe connection according to claim 5, characterized in that the end section (4) in the form of a sleeve end, of the other pipe (3) comprises at least one, in particular two, predetermined bending point(s) (20).

7. A jacket pipe connection according to claim 6, characterized in that predetermined bending point(s) (20) are comprised of material tapers, grooves, flutes (21) or the like.

8. A jacket pipe connection according to claim 6 or 7, characterized in that at least one predetermined bending point (20) is formed on the inner circumference of the end section (4) in the form of a sleeve end, of the other pipe (3), and that the at least one predetermined bending point (20) is spaced apart from the free end (9) of the sleeve end by the mean diameter of the depression.

9. A jacket pipe connection according to claim 6 or 7, characterized in that at least one further predetermined bending point (20) is formed on an outer circumference of the end section (4) in the form of a sleeve end, of the other pipe (3), and that said at least one further predetermined bending point (20) is formed to be offset relative to the at least one first predetermined bending point (20) in the direction of the free end of the sleeve end.

10. A device for forming a jacket pipe connection according to any one of claims 1 to 9, including a clamping or holding device for holding an end section of a pipe, in particular a mountain-side pipe, which end section is designed as a sleeve end, a guiding and adjusting device for introducing into the end section designed as a sleeve end a pipe section of another pipe, in particular an extension pipe, which pipe section is designed as a pointed end, characterized in that a pressing device for pressing the free end (9) of the pipe section (4) designed as a sleeve end into the depression (5) of the pipe section of the other pipe (1), which pipe section is designed as a pointed end (2), by applying a pressure force, in particular a pressure force directed radially to the pipe interior, comprises a pressing element (11, 15) and a device (12) for applying a pressure force on the pressing element, that the pressing element is configured as an expansion sleeve (15) provided with a pressing cone (11).

11. A device according to claim 10, characterized in that the guiding and adjusting device comprises a stroke or displacement path corresponding to a depth of penetration of the pipe section designed as a pointed end into the end section (4) designed as a sleeve end.

12. A device according to claim 10, characterized in that the pressing element is an expansion sleeve (15) provided with a pressing cone.

13. A device according to claim 10 or 11, characterized in that the device for applying the pressure force on the pressing element (12, 15) is comprised of a hydraulic cylinder in particular a double-acting hydraulic cylinder.

14. A device according to claim 13, characterized in that a pressing wedge (17) cooperating with the hydraulic cylinder (12) and/or fixed thereto acts on the resiliently mounted pressing element (12, 15), or pressing element configured as an expansion sleeve (15).
